(19) United States
(12) Patent Application Publication
(10) Pub. No.: US 2020/0253364 A1
(43) Pub. Date: Aug. 13, 2020

(54) Magnetic Multi-tool Carrier-and-Opener and Method of Use

(71) Applicant: Justin J. Myers, Plainfield, IL (US)

(72) Inventor: Justin J. Myers, Plainfield, IL (US)

(21) Appl. No.: 16/270,154

(22) Filed: Feb. 7, 2019

(51) Int. Cl. A45F 5/02; B25H 3/00

(52) U.S. Cl. CPC A45F 5/021; A45F 2200/0575; B25H 3/006

(57) ABSTRACT

A tool carrier-and-opener comprises a body, an adapter and a fastening element. The body includes a back segment, a pair of side segments extending inwardly from the back segment, and a magnet extending through an opening formed in the back segment. The magnet is preferably disposed along the longitudinal midline of the back segment and used to hold a tool, such as a multi-tool, housed in the body. In preferred embodiments, the magnet is rubber-coated to grip and stabilize the tool. The multi-tool can be removed from the carrier-and-opener by sliding the multi-tool upward to exit from the top of the body or by pushing the multi-tool forward to exit from the front of the body. Once the multi-tool is removed, it can be opened using the magnet. Both the removal and opening of the multi-tool can be accomplished singlehandedly by a user.

### FIELD OF THE INVENTION

The present invention relates to a carrier for a tool and, in particular, to a magnetic carrier that can be used to hold a multi-tool and open the multi-tool when removed from the carrier.

### BACKGROUND OF THE INVENTION

Many military personnel, first responders, including firefighters, law enforcement agents and paramedics, and tradespersons, including construction workers, carpenters and machinists, utilize various sheaths, pouches and/or carriers to secure a tool or personal article to an easily accessible location on his or her person. Commonly, such carriers can be mounted on the belt of a user and the tool removed and holstered as needed.

One shortcoming of many existing tool sheaths is that they require the user to use two hands when removing the tool from the sheath, such as by unbuckling, unsnapping or unfastening the tool. Additionally, some tools, such as multi-tools or multipurpose tools, require two-handed opening after removal from a carrier. When a user is mid-step in a project, such as an installation or assembly project, he or she must pause to set down other materials being handled, freeing both hands for removal and opening of the multi-tool.

A sheath or carrier that would allow for one-handed removal and opening of a tool, such as a multi-tool, would improve the workflow of various home improvement and construction-related tasks and aid service personnel when responding to routine or emergency calls.

### SUMMARY OF THE INVENTION

Shortcomings of existing tool sheaths are overcome by a tool carrier-and-opener comprising:
(a) a body comprising:
   (i) a back segment with at least one opening formed therein, the back segment comprising a first longitudinal edge, a second longitudinal edge and a bottom edge;
   (ii) a pair of oppositely disposed first and second side segments, the first side segment extending inwardly from the first longitudinal edge of the back segment and the second side segment extending inwardly from the second longitudinal edge of the back segment;
   (iii) a tab extending inwardly from the bottom edge of the back segment; and
   (iv) at least one magnet extending through the opening of the back segment,
(b) an adapter attached to the back of the body, the adapter comprising a recessed portion for housing the at least one magnet; and
(c) a fastening element.

In some embodiments, the at least one magnet comprises a pair of spaced apart magnets.

In some embodiments, the fastening element is a full-loop or clamp-style belt clip attached to the back of the adapter.

In some embodiments, the body includes a pair of oppositely disposed first and second tension wings extending upwardly from the top of the first and second side segments of the body. The first and second tension wings can apply an inward pressure to hold a tool housed in the body.

In some embodiments, the body can include a pair of first and second tab segments extending inwardly from the first and second side segments, respectively.

In some embodiments, the first and second side segments taper toward the tab and the back segment includes a concave top portion.

The first side segment of the body can include hexagonal openings for receiving differently sized metric nuts.

The second side segment of the body can include hexagonal openings for receiving differently sized standard nuts.

In some embodiments, the at least one magnet is disposed along the longitudinal midline of the back segment and removably couples to a tool housed in the body.

In some embodiments, the magnet is coated with a friction inducing material. In a preferred embodiment, the magnet is rubber-coated.

The tool carrier-and-opener can be used to open the tool after removal from the body.

In some embodiments, the tool is a multi-tool.

In some embodiments, the tool carrier-and-opener includes a pocket disposed between the adapter and the fastening element that holds a drill bit kit. In these embodiments, the fastening element is attached to the back of the pocket.

An improved method for one-handed deployment of a multi-tool comprises:
(a) affixing a multi-tool housed in a carrier to the body of a user, the carrier including at least one magnet disposed along the longitudinal midline of the back segment of the carrier;
(b) removing the multi-tool from the carrier;
(c) attaching a surface of a first arm of the multi-tool to the magnet of the carrier;
(d) opening the multi-tool by moving a second arm of the multi-tool in a clockwise motion; and
(e) leveraging the multi-tool out of the carrier,

When the first arm is attached to the magnet, the length of the multi-tool is disposed substantially perpendicular to the length of the back segment. The multi-tool can be opened by moving the second arm from an approximately 6 o'clock position to an approximately 12 o'clock position. The multi-tool can be leveraged out of the carrier by continuing the clockwise motion of the second arm.

In some embodiments, removing the multi-tool from the carrier is done by the user sliding the multi-tool in an upward motion to exit from the top of the carrier.

In some embodiments, removing the multi-tool from the carrier is done by the user pushing the multi-tool in a forward motion to exit from the front of the carrier.

### BRIEF DESCRIPTION OF THE DRAWINGS

FIG. 1A is an exploded, front perspective view of a tool carrier-and-opener.

FIG. 1B is an exploded, rear perspective view of a tool carrier-and-opener.

FIG. 2A is a front perspective view of a tool carrier-and-opener.

FIG. 2B is a rear perspective view of a tool carrier-and-opener.

FIG. 2C is a front view of a tool carrier-and-opener.

FIG. 2D is a rear view of a tool carrier-and-opener.

FIG. 2E is a first side view of a tool carrier-and-opener.

FIG. 2F is a second side view of a tool carrier-and-opener.

FIG. 2G is a front view of a tool carrier-and-opener with front tabs.

FIG. 3A is a top view of a tool carrier-and-opener.

FIG. 3B is an enlarged, transparent view of detail A of FIG. 3A.

FIG. 4A is a front perspective view of a multi-tool housed in a tool carrier-and-opener.

FIG. 4B is a front view of a multi-tool housed in a tool carrier-and-opener.

FIG. 4C is a rear perspective view of a multi-tool housed in a tool carrier-and-opener.

FIG. 4D is a rear view of a multi-tool housed in a tool carrier-and-opener.

FIG. 5A is a top view of a multi-tool housed in a tool carrier-and-opener.

FIG. 5B is an enlarged, transparent view of detail A of FIG. 5A.

FIG. 6 is an exploded, front perspective view of another embodiment of a tool carrier-and-opener.

FIG. 7 is an exploded, rear perspective view of another embodiment of a tool carrier-and-opener.

FIG. 8A is a front perspective view of another embodiment of a tool carrier-and-opener.

FIG. 8B is a front view of another embodiment of a tool carrier-and-opener.

FIG. 8C is a cross-sectional view of section B-B of FIG. 8B.

FIG. 8D is a rear view of another embodiment of a tool carrier-and-opener.

FIG. 8E is a first side view of another embodiment of a tool carrier-and-opener.

FIG. 8F is a second side view of another embodiment of a tool carrier-and-opener.

FIG. 9A is a top view of another embodiment of a tool carrier-and-opener.

FIG. 9B is an enlarged, transparent view of detail A of FIG. 9A.

FIG. 10 is a front perspective view of another embodiment of a tool carrier-and-opener with front tabs.

FIG. 11A is a front perspective view of a first method for removing a multi-tool from a tool carrier-and-opener.

FIG. 11B is a rear perspective view of a first method for removing a multi-tool from a tool carrier-and-opener.

FIG. 12A is rear perspective view of a second method for removing a multi-tool from a tool carrier-and-opener.

FIG. 12B is a front perspective view of a second method for removing a multi-tool from a tool carrier-and-opener.

FIG. 13A is a perspective view of an unopened multi-tool positioned in a tool carrier-and-opener such that the multi-tool can be opened.

FIG. 13B is a perspective view of the multi-tool of FIG. 9A that has been partially opened.

FIG. 13C is a perspective view of the multi-tool of FIG. 9A positioned for removal of the multi-tool from the tool carrier-and-opener.

FIG. 14A is a side view of an unopened multi-tool positioned in a multi-tool carrier-and-opener such that the tool can be opened.

FIG. 14B is a side view of the multi-tool of FIG. 9A that has been partially opened.

FIG. 14C is a side view of the multi-tool of FIG. 9A positioned for removal of the multi-tool from the tool carrier-and-opener.

### DETAILED DESCRIPTION OF ILLUSTRATIVE EMBODIMENT(S)

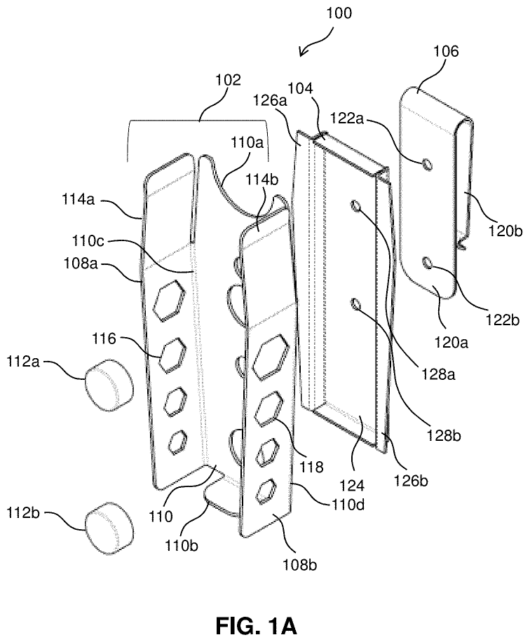

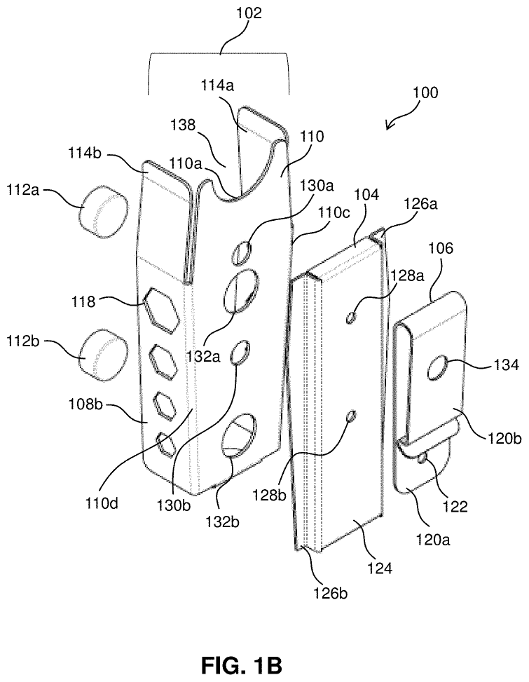

FIGS. 1A and 1B illustrate tool carrier-and-opener 100. As shown, tool carrier-and-opener 100 includes body 102, adapter 104 and fastening element 106. In some embodiments, the fastening element can be a clip 106, such as a full-loop or clamp-style belt clip. Body 102 includes back segment 110 and oppositely disposed sides 108a and 108b extending inwardly from longitudinal ends 110c and 110d of back segment 110. Body 102 can include tab 110b extending inwardly from the bottom of back segment 110. In some embodiments, tab 110b prevents a tool housed in body 102 from slipping out of the bottom of the carrier. Body 102 can also include concave or depressed top 110a. Back segment 110, sides 108a and 108b and tab 110b create cavity 138 (shown in FIG. 1B) for housing a tool. Back segment 110, sides 108a and 108b and/or tab 110b can be made from suitable materials such as various metals including aluminum and titanium, plastics, metal alloys including aluminum alloys, various grades of steel, various grades of carbon steel and/or steel alloys.

In some embodiments, body 102 includes wings 114a and 114b extending upwardly from sides 108a and 108b, respectively. In some embodiments, wings 114a and 114b are tension wings that apply inward pressure to hold a tool housed in body 102. Wings 114a and 114b can be made from suitable materials such as various metals including aluminum and titanium, plastics, metal alloys including aluminum alloys, various grades of steel including spring steel, various grades of carbon steel and/or steel alloys.

In some embodiments, sides 108a and 108b taper from the side-wing interface to the bottom of body 102.

In some embodiments, wings 114a and 114b provide coverage and protection of the upper portion of a tool housed in body 102.

In some embodiments, wings 114a and 114b taper from the side-wing interface to the top of body 102 providing downward pressure on a tool housed in the body.

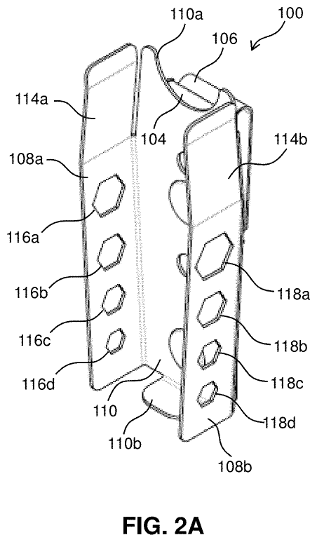

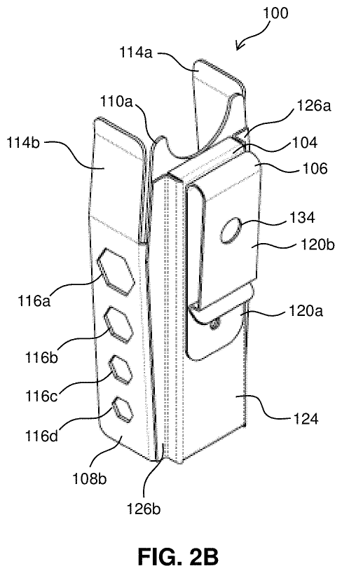

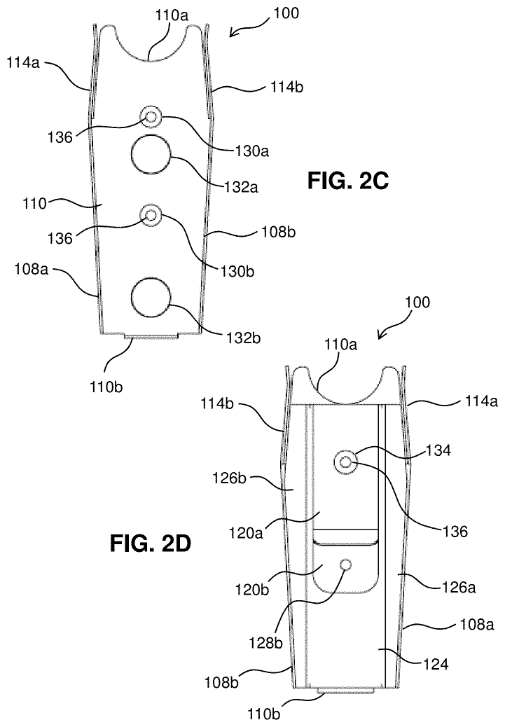

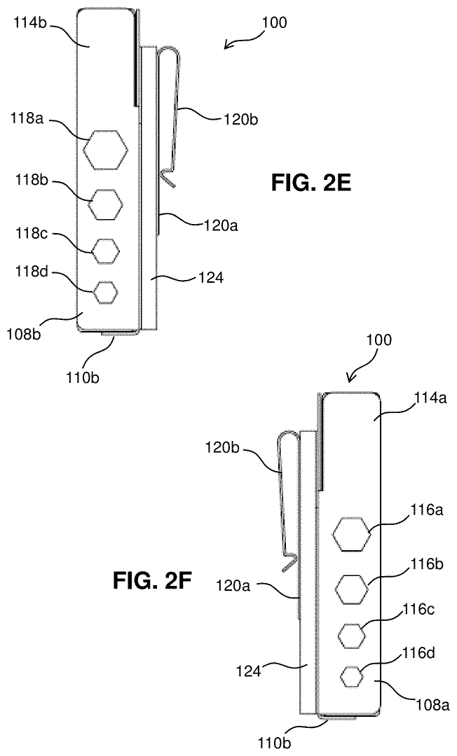

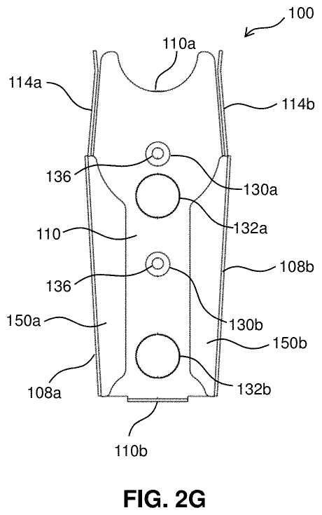

Side 108a can include a plurality of hexagonal openings 116 formed therein and side 108b can include a plurality of hexagonal openings 118 formed therein. As shown in FIG. 2A, each of hexagonal openings 116a-d are a different standard size. In some embodiments, standard hexagonal openings 116a, 116b, 116c and 116d are 7/16-inch, ⅜-inch, 5/16-inch and ¼-inch openings, respectively. Also shown in FIG. 2A, each of hexagonal openings 118a-d are a different metric size. In some embodiments, metric hexagonal openings 118a, 118b, 118c and 118d are M8, M6, M5 and M4 openings, respectively. Hexagonal openings 116 and 118 each receive correspondingly sized hexagonal nuts. Tool carrier-and-opener 100 can, therefore, be used as a wrench to tighten or loosen a nut with hexagonal openings 116 and 118.

As shown in FIG. 1B, back segment 110 has at least one opening formed therein for receiving a magnet. In some embodiments, back segment 110 can include openings 132a and 132b through which magnets 112a and 112b can be inserted. Magnets 112a and 112b are used to hold a tool housed in carrier and opener 100. In some embodiments, magnets 112a and 112b are disposed along the longitudinal midline of back segment 110 and allow a user to open a tool, such as a multi-tool, when removed from body 102.

Magnets 112a and 112b can be rubber-coated to increase friction for gripping and stabilizing a contacting surface of a tool housed within body 102. A rubber coating can also increase the durability of magnets 112a and 112b by preventing, or at least reducing, chipping or erosion of the magnets due to the friction created by sliding the tool past the magnets during insertion or removal from tool carrier-and-opener 100. The rubber coating also protects magnets 112a and 112b from exposure to liquids. Other suitable friction inducing coatings could be employed instead of rubber, such as those formed from resilient polymeric material.

In some embodiments, instead of rubber-coating magnets 112a and 112b, the inner facing surface of back segment 110 can be rubber-coated to increase friction for gripping and stabilizing a contacting surface of a tool housed within body 102.

In some embodiments, instead of magnets, body 102 or portions thereof, such as back segment 110, can be made of or include a ferromagnetic metal such as cobalt, iron, nickel, gadolinium, dysprosium, permalloy, awaruite, wairakite and/or magnetite. In some embodiments, the entirety of body 102 is magnetic. In some embodiments, the entirety of back segment 110 is magnetic.

Adapter 104 attaches to the back of body 102 via arms 126a and 126b and functions to connect body 102 to clip 106. Adapter 104 can include recessed portion 124 that houses magnets 112a and 112b extending through body 102. Clip 106 can be mounted via plate 120a such that openings 122a and 122b align with openings 128a and 128b of adapter 104 (FIG. 1A) and openings 130a and 130b of body 102 (FIG. 1B). Loop 120b of clip 106 includes opening 134 formed therein that aligns with openings 122a, 128a and 130a. In some embodiments, adapter 104 is press welded to the back of body 102 via arms 126a and 126b. Rivets or screws 136 (FIGS. 2C and 2D) can then be threaded through the various openings to secure clip 106 to the press welded body 102-adapter 104 assembly.

FIGS. 2A-2F illustrate various views of assembled tool carrier-and-opener 100.

In some embodiments, such as those illustrated in FIG. 2G, tool carrier-and-opener 100 can include tabs 150a and 150b extending inwardly from the longitudinal ends of sides 108a and 108b, respectively. In some embodiments, tabs 150a and 150b are disposed substantially perpendicular to sides 108a and 108b, respectively. Tabs 150a and 150b can aid in securing a tool housed in body 102.

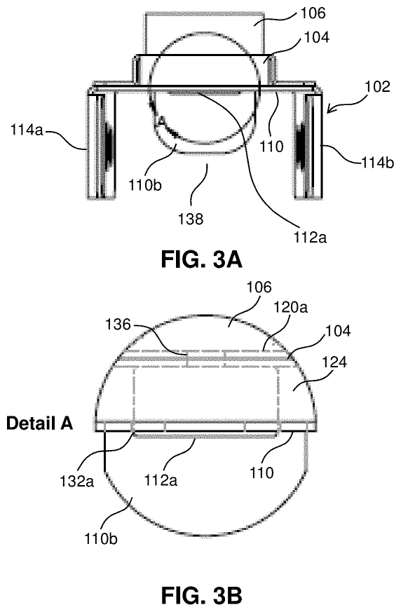

Turning now to FIGS. 3A and 3B, a top and an enlarged, transparent view of detail A of tool carrier-and-opener 100 are shown. As illustrated in FIG. 3B, when adapter 104 is mounted on body 102, magnets 112a and 112b (not shown) are inserted through openings 132a and 132b (not shown) of body 102 and extend through recessed portion 124 of adapter 104. In some embodiments, magnets 112a and 112b are potted with an adhesive for attachment to adapter 104. Magnets 112a and 112b can be flush with the inner-facing surface of back segment 110 or protrude into cavity 138, as shown in FIGS. 3A and 3B.

Rivet 136 extending through opening 122a (shown in FIG. 1A) of clip 106, opening 128a (shown in FIGS. 1A and 1B) of adapter 104 and opening 130a (shown in FIG. 1B) of body 102 is also illustrated in FIG. 3B.

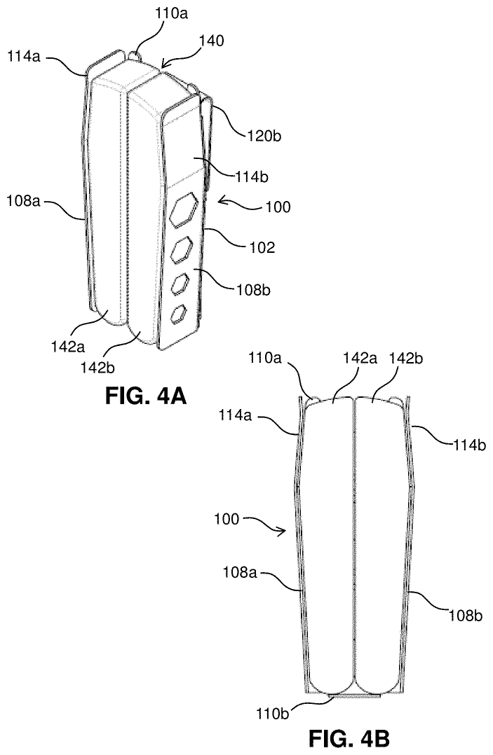

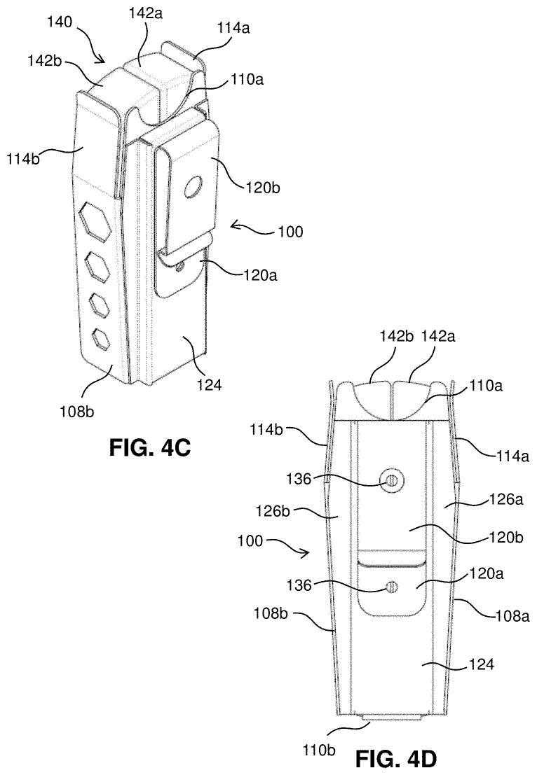

As shown in FIGS. 4A-4D, tool carrier-and-opener 100 can be used to house a tool. In some embodiments, tool carrier-and-opener 100 can hold an expandable or extending multi-tool. In some particular embodiments, tool carrier-and-opener 100 houses multi-tool 140 with expandable arms 142a and 142b. Multi-tool 140 can then be mounted to the belt of a user via loop 120b of clip 106. This allows the user to carry, store and access multi-tool 140 during work.

As further illustrated in FIGS. 4A-4D, wings 114a and 114b provide coverage and protection of the upper portion of multi-tool 140 when housed in body 102. In some embodiments, such as when tool carrier-and-opener 100 is affixed to the belt of a user, wings 114a and 114b prevent, or at least reduce, the upper, side portions of arms 142a and 142b from snagging on the belt or clothing of a user.

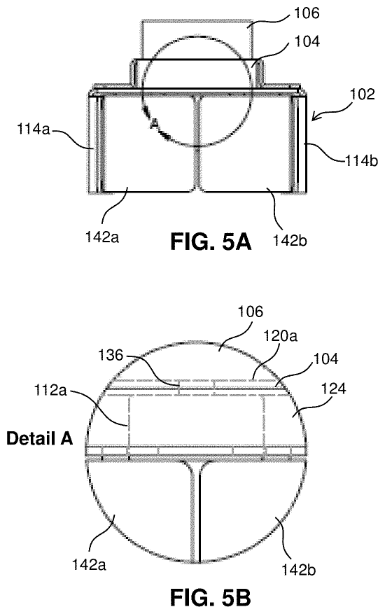

FIGS. 5A and 5B illustrate arms 142a and 142b of multi-tool 140 contacting magnets 112a and 112b (not shown) to hold the multi-tool in body 102 of tool carrier-and-opener 100.

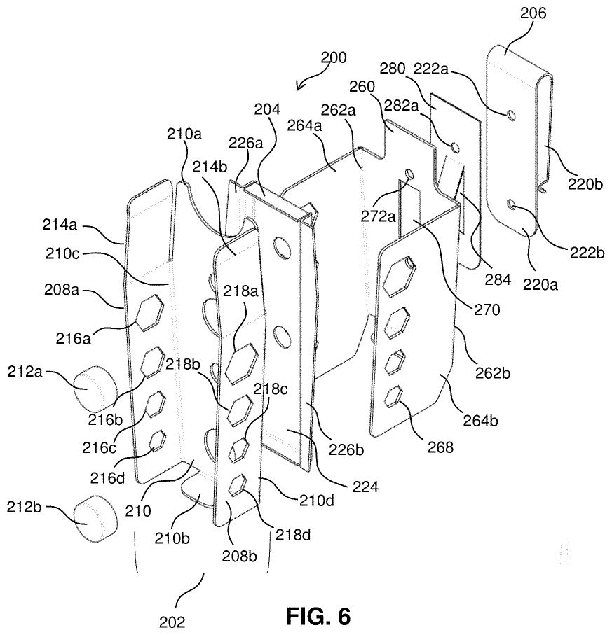

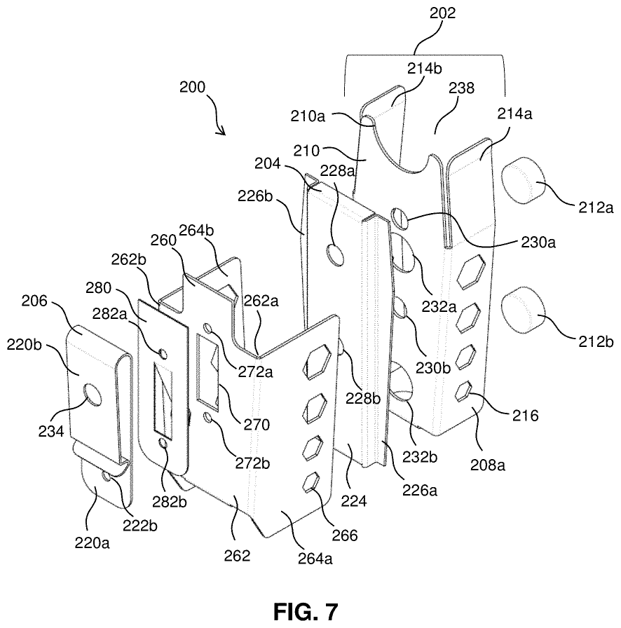

Turning now to FIGS. 6 and 7, another embodiment of a tool carrier-and-opener is shown. Tool carrier-and-opener 200 includes body 202, adapter 204, frame 260, spring plate 280 and fastening element 206. In some embodiments, the fastening element can be clip 206, such as a full-loop or clamp-style belt clip. Body 202 includes back segment 210 and oppositely disposed sides 208a and 208b extending inwardly from longitudinal ends 210c and 210d of back segment 210. Body 202 can include tab 210b extending inwardly from the bottom of back segment 210. In some embodiments, tab 210b prevents a tool housed in body 202 from slipping out of the bottom of the carrier. Body 202 can also include concave or depressed top 210a. Back segment 210, sides 208a and 208b and tab 210b create a cavity for housing a tool. Back segment 210, sides 208a and 208b, and/or tab 210b can be made from suitable materials such as various metals including aluminum and titanium, plastics, metal alloys including aluminum alloys, various grades of steel, various grades of carbon steel and/or steel alloys.

In some embodiments, body 202 includes wings 214a and 214b extending upwardly from sides 208a and 208b, respectively. In some embodiments, wings 214a and 214b are tension wings that apply inward pressure to hold a tool housed in body 202. Wings 214a and 214b can be made from suitable materials such as various metals including aluminum and titanium, plastics, metal alloys including aluminum alloys, various grades of steel including spring steel, various grades of carbon steel and/or steel alloys.

In some embodiments, sides 208a and 208b taper from the side-wing interface to the bottom of body 202.

In some embodiments, wings 214a and 214b provide coverage and protection of the upper portion of a tool housed in body 202.

In some embodiments, wings 214a and 214b taper from the side-wing interface to the top of body 202 providing downward pressure on a tool housed in the body.

Side 208a can include a plurality of hexagonal openings 216 formed therein and side 208b can include a plurality of hexagonal openings 218 formed therein. As shown in FIG. 6, each of hexagonal openings 216a-d are a different standard size. In some embodiments, standard hexagonal openings 216a, 216b, 216c and 216d are 7/16-inch, ⅜-inch, 5/16-inch and ¼-inch openings, respectively. Each of hexagonal openings 218a-d are a different metric size. In some embodiments, metric hexagonal openings 218a, 218b, 218c and 218d are M8, M6, M5 and M4 openings, respectively. Hexagonal openings 216 and 218 each receive correspondingly sized hexagonal nuts. Tool carrier-and-opener 200 can, therefore, be used as a wrench to tighten or loosen a nut with hexagonal openings 216 and 218.

As shown in FIG. 7, back segment 210 has at least one opening formed therein for receiving a magnet. In some embodiments, back segment 210 can include openings 232a and 232b through which magnets 212a and 212b can be inserted. Magnets 212a and 212b are used to hold a tool housed in carrier and opener 200. In some embodiments, magnets 212a and 212b are disposed along the longitudinal midline of back segment 210 and allow a user to open a tool, such as a multi-tool, when removed from body 202.

Magnets 212a and 212b can be rubber-coated to increase friction for gripping and stabilizing a contacting surface of a tool housed within body 202. A rubber coating can also increase the durability of magnets 212a and 212b by preventing, or at least reducing, chipping or erosion of the magnets due to the friction created by sliding the tool past the magnets during insertion or removal from tool carrier-and-opener 200. The rubber coating also protects magnets 212a and 212b from exposure to liquids. Other suitable friction inducing coatings could be employed instead of rubber, such as those formed from resilient polymeric material.

In some embodiments, instead of rubber-coating magnets 212a and 212b, the inner facing surface of back segment 210 can be rubber-coated to increase friction for gripping and stabilizing a contacting surface of a tool housed within body 202.

In some embodiments, instead of magnets, body 202 or portions thereof, such as back segment 210, can be made of or include a ferromagnetic metal such as cobalt, iron, nickel, gadolinium, dysprosium, permalloy, awaruite, wairakite and/or magnetite. In some embodiments, the entirety of body 202 is magnetic. In some embodiments, the entirety of back segment 210 is magnetic.

Adapter 204 attaches to the back of body 202 via arms 226a and 226b and includes recessed portion 224 for housing magnets 212a and 212b extending through body 202. In some embodiments, adapter 204 is press welded to the back of body 202 via arms 226a and 226b.

Frame 260 includes back segment 262 and oppositely disposed sides 264a and 264b extending inwardly from longitudinal ends 262a and 262b of back segment 262. Body 260 can include opening 270 formed therein.

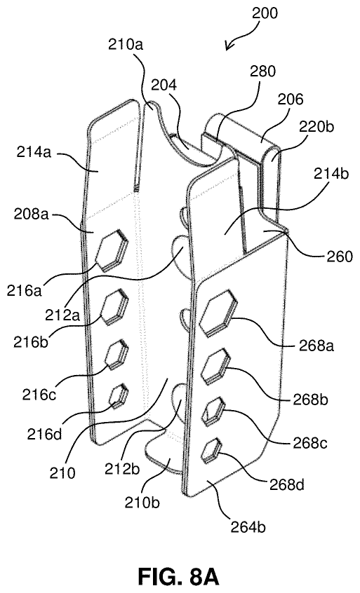

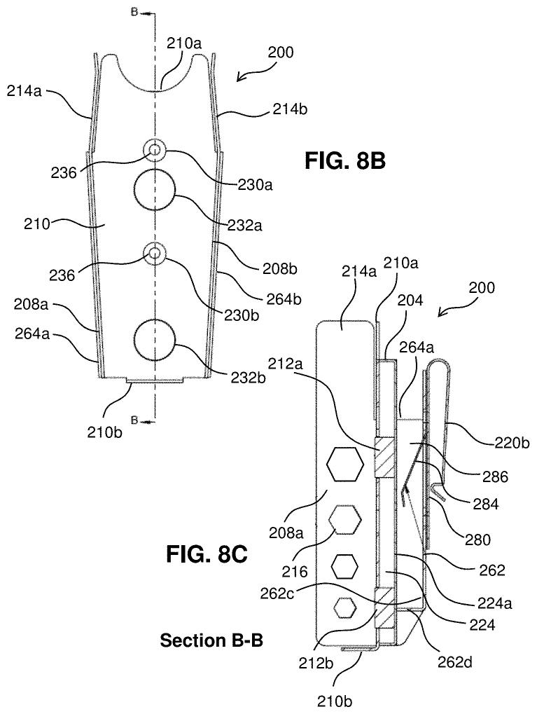

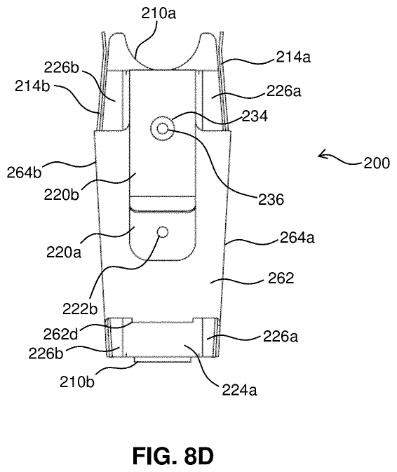

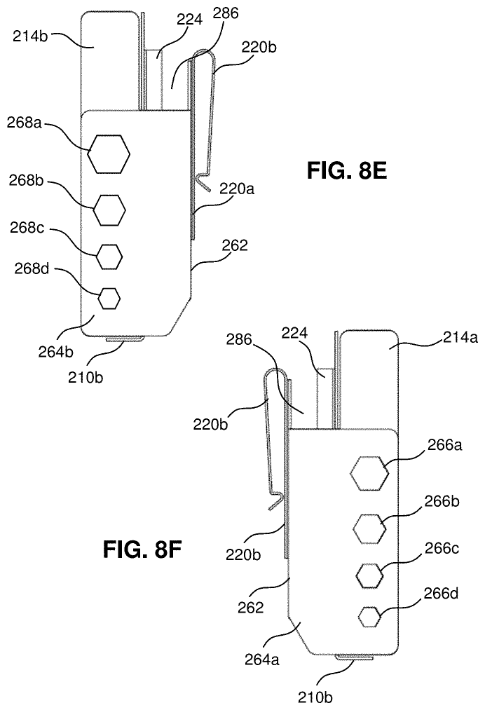

Side 264a can include a plurality of hexagonal openings 266 (shown in FIG. 7) formed therein and side 264b can include a plurality of hexagonal openings 268 (shown in FIG. 6) formed therein. As shown in FIG. 8F, each of hexagonal openings 266a-d are a different standard size. In some embodiments, standard hexagonal openings 266a, 266b, 266c and 266d are 7/16-inch, ⅜-inch, 5/16-inch and ¼-inch openings, respectively. As shown in FIG. 8E, each of hexagonal openings 268a-d are a different metric size. In some embodiments, metric hexagonal openings 268a, 268b, 268c and 268d are M8, M6, M5 and M4 openings, respectively.

Hexagonal openings 266 and 268 each receive correspondingly sized hexagonal nuts. Tool carrier-and-opener 200 can, therefore, be used as a wrench to tighten or loosen a nut with hexagonal openings 216 and 218.

In some embodiments, sides 264a and 264b of frame 260 attach to sides 208a and 208b, respectively, of body 202 after adapter 204 is attached to back 210 of body 202 via arms 226a and 226b. In some embodiments, frame 260 can be press welded to body 202 via sides 264a and 264b.

When tool carrier-and-opener 200 is assembled, hexagonal openings 266 and 268 of frame 260 align with hexagonal openings 216 and 218, respectively, of body 202.

Spring plate 280 can be mounted to the back of frame 260 such that spring 284 extends through opening 270 of frame 260.

Clip 206 can be mounted via plate 220a such that openings 222a and 222b align with openings 282a and 282b of spring plate 280, openings 272a and 272b of frame 260, openings 228a and 228b of adapter 204 and openings 230a and 230b of body 202. Loop 220b of clip 206 includes opening 234 formed therein that aligns with openings 282a, 272a, 228a and 230a. Rivets or screws 236 (shown in FIGS. 8B and 8D) can then be threaded through the various openings to secure spring plate 280 and clip 206 to the press welded body-adapter-frame assembly.

FIGS. 8A-8F illustrate various views of assembled tool carrier-and-opener 200.

As shown in FIG. 8C, a cross-sectional view of FIG. 8B, tool carrier-and-opener 200, when assembled, has pocket 286 created by rearward-facing surface 224a of recessed portion 224 of body 204 and forward-facing surface 262c and bottom 262d of back segment 262 of frame 260. In some embodiments, pocket 286 can be used to hold equipment, such as a bit kit, that can be removed from pocket 286 via internal spring 284.

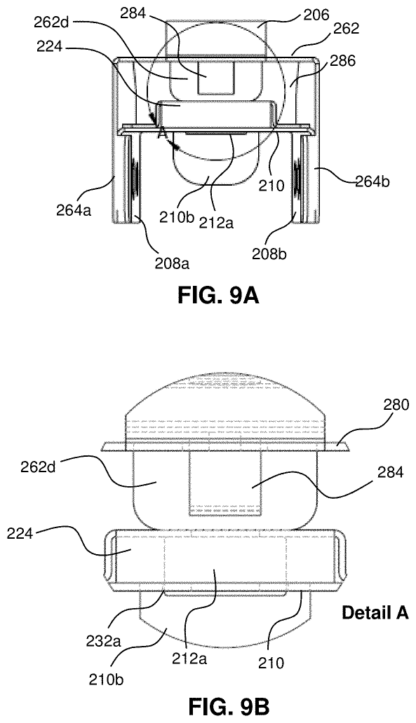

Turning now to FIGS. 9A and 9B, a top and an enlarged, transparent view of detail A of tool carrier-and-opener 200 are shown. As illustrated in FIG. 9B, when adapter 204 is mounted on body 202, magnets 212a and 212b (not shown) are inserted through openings 232a and 232b (not shown) of body 202 and extend through recessed portion 224 of adapter 204. In some embodiments, magnets 212a and 212b are potted with an adhesive for attachment to adapter 204. Magnets 212a and 212b can be flush with the inner-facing surface of back segment 210 or protrude into the cavity. As further shown in FIGS. 9A and 9B, spring 284 extends into pocket 286.

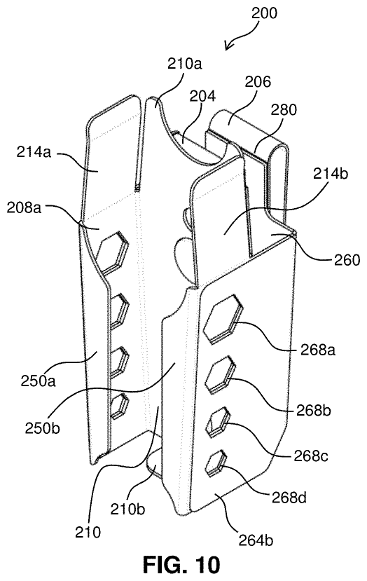

In some embodiments, such as those illustrated in FIG. 10, tool carrier-and-opener 200 can include tabs 250a and 250b extending inwardly from the longitudinal ends of sides 208a and 208b, respectively. In some embodiments, tabs 250a and 250b are disposed substantially perpendicular to sides 208a and 208b, respectively. Tabs 250a and 250b can aid in securing a tool housed in body 202.

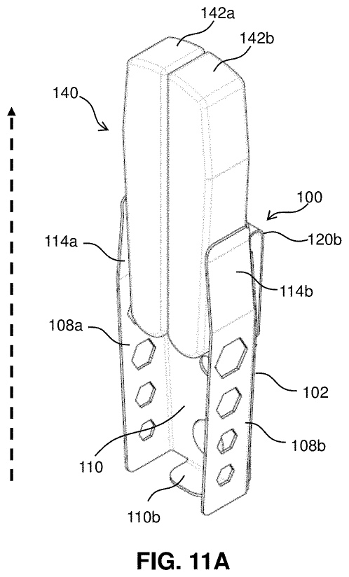

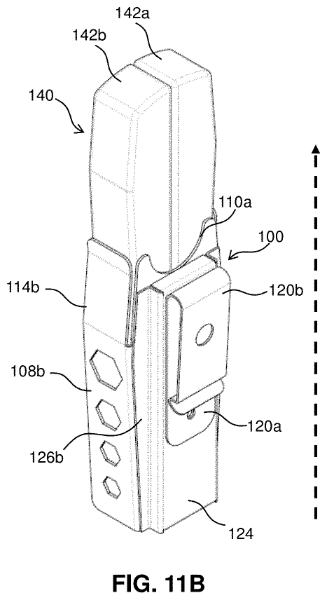

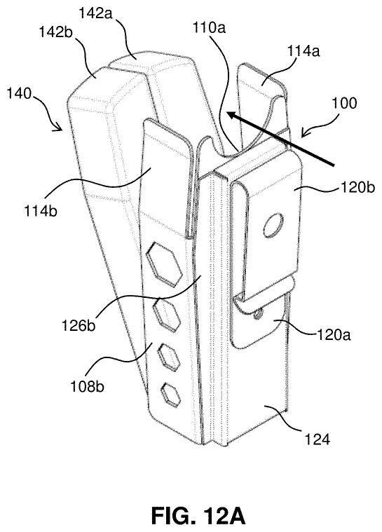

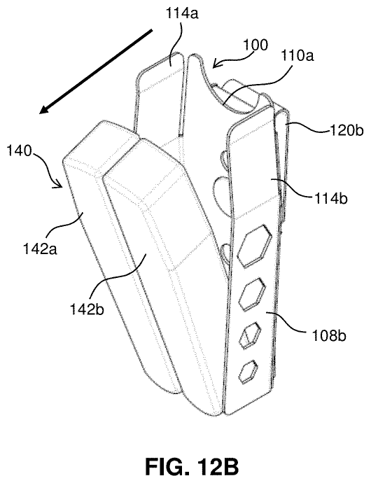

The design of tool carrier-and-opener 100 allows a user to remove multi-tool 140 from body 102 with a single hand. As shown in FIGS. 11A and 11B, a user can remove multi-tool 140 by sliding arms 142a and 142b upwardly out of body 102 (upward motion indicated by dashed arrows). Alternatively, as shown in FIGS. 12A and 12B, the user can apply pressure to the back surface of multi-tool 140, exposed via concave top 110a, to push the multi-tool forward (forward motion indicated by solid arrows). Multi-tool 140 can then be grasped and removed from body 102 of tool carrier-and-opener 100.

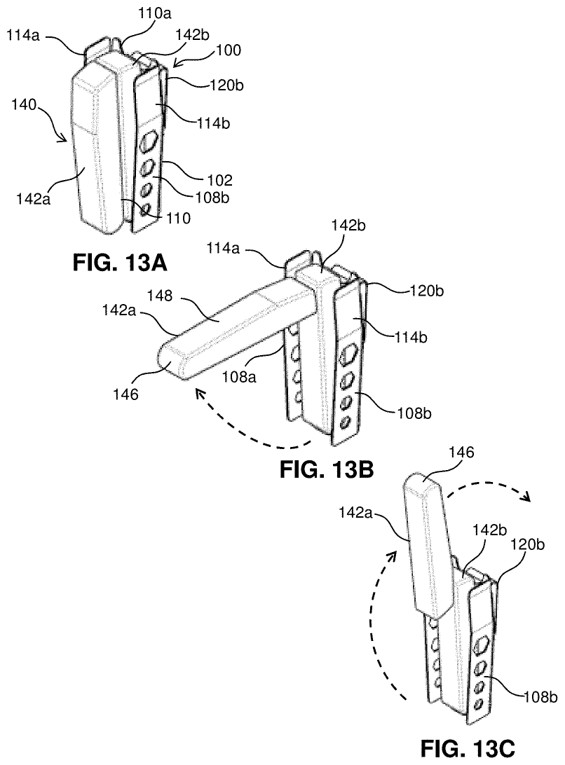

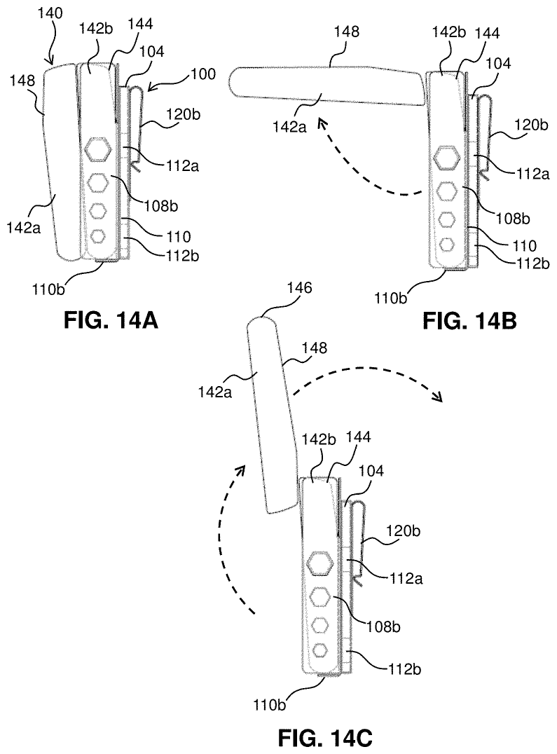

FIGS. 13A-13C and 14A-14C illustrate a method for using tool carrier-and-opener 100 to open a multi-tool once the multi-tool is removed from body 102. As shown in FIGS. 13A and 14A, once multi-tool 140 is removed from body 102, surface 144 (shown in FIGS. 14A-14C) of arm 142b can be affixed to magnets 112a and 112b (shown in FIGS. 14A-14C) along the longitudinal midline of back segment 110. The user can then open multi-tool 140 by moving arm 142a upward in a clockwise motion as illustrated in FIGS. 13A and 14B (upward motion indicated by dashed arrows). Once distal end 146 of arm 142a reaches an upward-facing position, illustrated in FIGS. 13C and 14C, the user can continue the clockwise motion to draw surface 148 (shown in FIGS. 13B and 14A-14C) of arm 142a toward surface 144 of arm 142b, leveraging multi-tool 140 out of body 102 and fully opening the multi-tool. In some embodiments, arm 142a moves from an approximately 6 o'clock (FIGS. 13A and 14A) to a 9 o'clock (FIGS. 13B and 14B) to a 12 o'clock (FIGS. 13C and 14C) position during opening.

The initial removal, that is, prior to opening the tool (shown in FIGS. 11A, 11B, 12A and 12B), the opening (shown in FIGS. 13A-13C and 14A-14C) and the final removal, that is, after opening the tool, of multi-tool 140 can all be done with a single hand of a user, leaving the user's other hand free to handle other material(s) required for a particular project.

It will be understood that the descriptions herein of holding and opening a tool, such as a multi-tool, including the methods illustrated in FIGS. 4A-4D, 5A and 5B, 11A and 11B, 12A and 12B, 13A-13C and 14A-14C are equally applicable to tool carrier-and-holder 200.

Tool carrier-and-opener 100, or portions thereof, and tool carrier-and-opener 200, or portions thereof, can be manufactured via press forming, stamping, injection molding, additive manufacturing (3D printing), cold forming, heat bending or die casting.

Tool carrier-and-opener 100 or 200 can be various dimensions and scaled to house different tools. In some embodiments, such as when housing a multi-tool, tool carrier-and-opener 100 or 200 can have a width in the inclusive range of 1-2.25 inches (2.5-5.7 cm) and a height in the inclusive range of 3.25-5.5 inches (8.3-14 cm).

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. A tool carrier-and-opener comprising:
(a) a body comprising:
(i) a back segment having at least one opening formed therein, said back segment having a first longitudinal edge, a second longitudinal edge and a bottom edge;
(ii) a pair of oppositely disposed first and second side segments, said first side segment extending inwardly from said first longitudinal edge of said back segment and said second side segment extending inwardly from said second longitudinal edge of said back segment;
(iii) a bottom tab extending inwardly from said bottom edge of said back segment; and
(iv) at least one magnet extending through said at least one opening of said back segment,
(b) an adapter attached to the back of said body, said adapter comprising a recessed portion for housing said at least one magnet; and
(c) a fastening element.

2. The tool carrier-and-opener of claim 1, wherein said fastening element is a full-loop belt clip or a clamp-style belt clip attached to the back of said adapter.

3. The tool carrier-and-opener of claim 1, wherein said body further comprises:
(v) a pair of oppositely disposed first and second tension wing segments, said first tension wing extending upwardly from the top of said first side segment and said second tension wing segment extending upwardly from the top of said second side segment, wherein said first and second tension wing segments apply inward pressure to hold a tool housed in said body.

4. The tool carrier-and-opener of claim 1, wherein said body further comprises:
(v) a pair of first and second tab segments, said first tab segment extending inwardly from said first side segment and said second tab segment extending inwardly from said second side segment.

5. The tool carrier-and-opener of claim 1, wherein said first and second side segments taper toward said bottom tab and said back segment further comprises a concave top portion.

6. The tool carrier-and-opener of claim 1, wherein said first side segment of said body has a plurality of hexagonal openings formed therein, each of said plurality of hexagonal openings sized to receive a different metric nut size.

7. The tool carrier-and-opener of claim 1, wherein said second side segment of said body has a plurality of hexagonal openings formed therein, each of said plurality of hexagonal openings sized to receive a different standard nut size.

8. The tool carrier-and-opener of claim 1, wherein said at least one magnet is disposed along the longitudinal midline of said back segment of said body.

9. The tool carrier-and-opener of claim 8, wherein said at least one magnet removably couples to a tool housed in said body and opens said tool after removal from said body.

10. The tool carrier-and-opener of claim 9, wherein said at least one magnet is coated with a friction-inducing material to grip and stabilize a contacting surface of said tool.

11. The tool carrier-and-opener of claim 10, wherein said at least one magnet is rubber-coated.

12. The tool carrier-and-opener of claim 9, wherein said tool is a multi-tool.

13. The tool carrier-and-opener of claim 1, further comprising:
(d) a pocket disposed between said adapter and said fastening element, said pocket configured to hold a bit kit, wherein said fastening element is attached to the back of said pocket.

14. The tool carrier-and-opener of claim 8, wherein said at least one magnet comprises a first magnet and a second magnet, said first magnet extending through a first opening formed in said back segment and said second magnet extending through a second opening formed in said back segment.

15-20. (canceled)
